(19) United States
(12) Patent Application Publication
(10) Pub. No.: US 2010/0116202 A1
(43) Pub. Date: May 13, 2010

(54) Modular Chambers for Manufacturing Magnetic Disks

(76) Inventors: Mark Smura, Palo Alto, CA (US); Paul Stephen McLeod, Berkeley, CA (US)

Correspondence Address: MURABITO, HAO & BARNES, LLP, TWO NORTH MARKET STREET, THIRD FLOOR, SAN JOSE, CA, 95113, US

(21) Appl. No.: 12/266,915

(22) Filed: Nov. 7, 2008

(51) Int. Cl. B05C 21/00; B05C 13/02

(52) U.S. Cl. 118/500

(57) ABSTRACT

A modular chamber design for manufacturing magnetic disks is provided. The modular chambers are linearly aligned, have a trapezoidal shape, and are inversely oriented. In this inverse orientation, a chamber can be exchanged and/or removed without first having to laterally move the other chambers to create space on each side of the chamber being moved. Because the modular chamber design decreases the amount of time and labor required to exchange or replace chambers in a disk processing line, disk throughput is increased. Thus, the modular chamber design facilitates faster and more efficient chamber exchange/removal.

### FIELD OF THE INVENTION

The present invention relates to the manufacture of magnetic disks and, more particularly, a modular configuration for linearly aligned chambers used in the manufacture of such disks.

### BACKGROUND OF THE INVENTION

Hard disk drives are an efficient and cost effective solution for data storage. Depending upon the requirements of the particular application, a disk drive may include from one to multiple hard disks and data may be stored on one or both surfaces of each disk. While hard disk drives are traditionally thought of as a component of a personal computer or as a network server, usage has greatly expanded to include other storage and retrieval applications such as set top boxes for recording and time shifting of television programs, personal digital assistants, cameras, music players and many other consumer and industrial electronic devices, each having different information storage capacity requirements.

Typically, hard memory disks are produced with functional magnetic recording capabilities on one or both surfaces of the disk. In conventional practice, these hard disks are produced by subjecting one or both sides of a substrate disk, such as glass, ceramic, metal or metal alloy, typically an aluminum based alloy, or some other suitable material, to numerous manufacturing processes. Active materials are deposited on one or both sides of the substrate disk and one or both sides of the disk are subject to full processing such that one or both sides of the substrate disk may be referred to as active or functional from a memory storage stand point. The end result is that one or both sides of the finished disk have the necessary materials and characteristics required to effect magnetic recording and provide data storage.

The processing of both single-sided and double-sided hard memory disks involve a number of discrete process steps usually performed in a clean-room environment. Typically, twenty-five substrate disks are placed in a plastic cassette or carrier, axially aligned in a single row. Because the disk manufacturing processes are typically conducted at adjacent locations using different equipment, the cassettes are moved from process station to process station. For some processes, the substrate disks are individually removed from the cassette by automated equipment, one or both surfaces of each disk are subjected to the particular process, and the processed disk is returned to the cassette. Alternatively, in some processes, a plurality of disks are simultaneously processed. For example, in some instances one or more entire cassettes of disks may be simultaneously processed. Once the disks have been fully processed and returned to the cassette, the cassette is transferred to the next station for further processing of the disks.

More particularly, in a conventional disk manufacturing process, the substrate disks are initially subjected to data zone texturing. Texturing prepares the surfaces of the substrate disk to receive layers of materials which will provide the active or memory storage and retrieval capabilities on each disk surface. Texturing is typically accomplished by either fixed abrasive texturing or free abrasive texturing. Following texturing, the cassette is typically moved to an adjacent station for washing. Washing is a multi-stage process that usually includes scrubbing of the disk surfaces in the presence of cleaning liquids or water. The textured substrate disks are then subjected to a drying process. Drying is typically performed on all of the disks from an entire cassette at the same time.

Following the drying process, the disks are returned to the cassette and it is moved to the laser zone texturing station where a laser beam is focused on and interacts with discrete portions of the disk surface to create an array of bumps upon which the head and slider assembly will land on and take off. Laser zone texturing is typically performed one disk at a time. Again, the cassette is transported to succeeding stations for washing and drying process steps.

Following the last drying step, the disks are then subjected to a process which adds layers of materials to either one or both surfaces for purposes of creating data storage and retrieval capabilities. The disks may be processed individually or in groups. The deposition of material layers onto the substrate may be accomplished by sputtering or by other techniques known to persons of skill in the art. The sputtering process is typically conducted in a series of vacuum chambers. FIG. 1 depicts a row of linearly aligned and interconnected chambers 10 where disks 12 move from one chamber to the next, for example from chamber 10a to 10b to 10c, etc. The disks 12 travel through the row of interconnected chambers 10 using automated means known to those of skill in the art. Conventional process chambers 10 are typically rectangular in configuration and adjacent process chambers, for example chambers 10b and 10c in FIG. 1, and are typically connected to one another via their abutting sidewalls 14.

Typically, the first one or two chambers, for example 10a and 10b, add a soft under layer, for example an iron cobalt alloy, to the substrate. The under layer facilitates the magnetic flux path during read and/or write operations. Several deposition chambers 10c, 10d and 10e usually follow the initial chambers 10a and 10b. Two common types of deposition processes include vacuum deposition and magnetron sputtering. In a vacuum sputtering process, following the depositing of an underlayer, a magnetic recording layer and then an overcoat layer are added onto the surface or surfaces of each disk. Vacuum sputtering is accomplished by applying a voltage between the depositing material (the cathode) and the grounded chamber walls (the anode) in a vacuum chamber containing a sputtering gas such as argon. With magnetron sputtering a magnetic array is placed on the backside of a sputtering target. When a negative voltage is applied to the sputtering target the resulting negative field attracts positive ions to the sputtering target. When a positive ion collides with atoms at the surface of the sputtering target a surface atom becomes sputtered. Subsequent to the sputtering chambers the substrate disks are cooled in one or more cooling chambers, for example 10e, etc.

Following the addition of sequentially deposited layers to one or both disk surfaces 16, a lubricant layer typically is applied in a subsequent process. Typically, the lubrication process is accomplished by subjecting an entire cassette of disks to a liquid lubricant. After the lubrication process, the disks 12 are typically moved to the next station and subjected to surface burnishing to remove asperities, enhance bonding of the lubricant to the disk surface and otherwise provide a generally uniform finish to the disk surface 16. Following burnishing, the substrate disks can also be subjected to various types of testing.

FIG. 2 illustrates the conventional manner of interconnecting and sealing adjacent chambers, for example, chambers 10d and 10e. Adjacent chamber sidewalls 14d and 14e must be sealed in order to maintain the necessary vacuum pressure. Typically, an o-ring 20 provides the means for sealing adjacent chamber sidewalls 14d and 14e together. As illustrated in FIGS. 2, 3 and 4, in a conventional chamber 10, one sidewall 14d is machined to provide a groove 22 to receive an o-ring 20. An o-ring 20 is then positioned within the groove 22. The groove 22 surrounds an opening 24 in the sidewalls of each chamber 10 through which the disks 12 are transported from one chamber to the next, for example from 10d to 10e. The abutting sidewall 14e from the adjacent chamber 10e is machined to provide a smooth surface to abut the o-ring 20. The adjacent chambers 10d and 10e are sealed by compressing the o-ring 20 between the two adjacent chamber sidewalls 14d and 14e. FIG. 4 shows a cross-sectional view of two adjacent chamber sidewalls 14d and 14e compressing the o-ring 20 to provide effective sealing means between the process chambers 10d and 10e.

The adjacent chambers 10d and 10e are fastened together to compress the o-ring 20 and form a seal. As illustrated in FIG. 2, alignment pins 26 are provided on the chamber sidewall 14d to align adjacent chambers 10d and 10e for physical interconnection. Once the chambers 10d and 10e are proximally in place, each alignment pin 26 of one chamber sidewall 14d is received by a cooperating opening or slot on the adjacent chamber sidewall 14e (not shown). As further illustrated in FIG. 2, cutouts or recesses 28 are provided adjacent to the four corners 30 of each sidewall 14d and 14e to allow access to the head of a bolt 18 and a complementary nut (not shown) for physically interconnecting the adjacent chambers 10d and 10e. In other embodiments, the chambers 14 may be physically interconnected by means of C-clamps spanning the complementary recesses 28. The alignment pins 26 may be used to properly align the adjacent chambers 10d and 10e and then the C-clamps may be clamped onto the cutouts 28. In yet other embodiments, a threaded bolt 18 may extend from one side wall 14d and interconnect with a threaded bore in the sidewall 14e of the adjacent chamber 10e (not shown). Because the chambers 10 are frequently and repeatedly subjected to vacuum pressures and because disks are transferred between chambers it is important to ensure that adjacent chambers 10d and 10e are reliably and securely physically interconnected. Further still, in some circumstances it is acceptable to weld adjacent process chambers 10d and 10e together in order to effectively seal chambers together to achieve sealing. Welding chambers together can be very costly to the overall disk processing line because it inhibits later chamber exchange and repair.

One disadvantage to axially aligned and interconnected rectangular process chambers is that removal of one chamber 10 from the row of chambers 10 is difficult and time consuming. A chamber 10 may need to be removed from the process line for numerous reasons including maintenance, repair, cleaning, upgrade, and exchange. Routine maintenance and/or repair is not always possible unless the chamber 10 is removed from the row of chambers. In addition, the individual layer deposition processes used in manufacturing disks have evolved over time and continue to change. Thus, many process chambers also become replaced and/or retrofitted as newer technology emerges. However, in each of these instances manufacturers are forced to sacrifice disk throughput while the process line is stopped so that the chambers may be serviced, upgraded or exchanged. If a chamber 10 is to be removed from a row of chambers, a significant number of electrical lines and plumbing lines initially must be disconnected. Next, the mechanical interconnections must be disconnected, followed by removal of the desired chamber. However, when the target chamber 10d is moved, a resulting shearing force is exerted on the o-ring 20. FIG. 5 shows a cross-sectional view of the shearing forces exerted on the o-ring 20 as a result of moving one chamber 10d relative to an adjacent chamber 10e. This relative motion between the chambers 10d and 10e will twist and perhaps tear the o-ring 20. Similarly, upon replacement of the repaired or new chamber, the shear force applied by reinserting the target chamber 10d into the row of chambers may dislodge the o-ring 20 from the groove 22 and/or damage the o-ring 20, preventing a seal from being achieved. However, it may not be evident that no seal has been achieved until after the processing line is completely reconnected and processing is resumed. If a seal has not been achieved between one or more chambers, the process must again be shut down and the chambers disconnected and separated to correct the problem. Further downtime results in further loss of production time and revenues.

FIGS. 6A-6C illustrate the conventional chamber exchange/removal process. FIG. 6A illustrates an in-line row of interconnected chambers 10a-10e. First, the electric, plumbing and other connecting lines of the chambers 10a-10e must be disconnected and moved as appropriate. Second, the alignment pins, bolts, and/or other securing means must be removed in order to decouple the target chamber 10d from its adjacent chambers 10c and 10e. Then, as shown in FIG. 6B, the target chamber 10d itself must be laterally separated on both sides from its adjacent chambers 10c and 10e which entails moving all of the chambers comprising the in-line row of chambers 10a-10e. To ensure the sealing elements are not compromised a physical gap 32 must be present on both sides of the target chamber 10d before the target chamber 10d can be removed from the process line. Once the adjacent chambers 10c and 10e have been literally separated from the target chamber 10d, it can be removed orthogonally from the process line as shown in FIG. 6C. Once the necessary chamber modification or exchange is made the target chamber 10d or its replacement the target chamber 10d must be reinstalled and reconnected to the process line. Again, reconnection is a time consuming and costly process. For example, the target chamber 10d must be re-aligned with its adjacent chambers 10c and 10e with all of the adjacent chambers laterally moved inwardly, the alignment pins 26 must be inserted into the complementary mating apertures in adjacent chambers, the target chamber 10d must be mechanically recoupled with the adjacent chambers 10c and 10e and last, all the necessary electrical, plumbing and other connecting lines must be reconnected. All this time, the process line is not making disks. Thus, substantial savings could be achieved by exchanging chambers in a more time and cost efficient manner.

Accordingly, there is a need within the disk processing and manufacturing industry for a system that facilitates exchange of the modular process chambers without requiring substantial labor or effort, or that at least minimize the amount of labor needed. In addition, there is a need within the art of disk processing to facilitate the movement, exchange, and maintenance of process chambers without undue process line interruption in order to minimize disruption to disk throughput. Still further there is a need to prolong the useable lifetime of a chamber's sealing means by designing chambers to reduce the shearing forces exerted on the sealing means when the chambers are exchanged. Furthermore, there is a need within the art to have a design that facilitates exchange of modular chambers in order to implement newer and more advanced technology into the process chambers.

### SUMMARY OF THE INVENTION

The design to facilitate exchange of modular chambers generally comprises a plurality of trapezoidal shaped chambers. In one embodiment, the chambers have an isosceles trapezoidal shape, although other trapezoidal shapes will work too. This trapezoidal chamber design has many advantages, including decreasing the amount of time and labor required to exchange or replace chambers in a contiguous line of chamber.

The present invention provides advantages over the prior art in that trapezoidal chambers facilitate faster and more efficient chamber removal and/or exchange. Decreasing the amount of process line interruption increases disk throughput by increasing the speed with which the chambers can be replaced and/or exchanged. More specifically, when removing a chamber from a line of interconnected chambers, none of the other chambers need to be moved to create lateral space on each side of the chamber being moved. Any chamber may be orthogonally removed or inserted into a line of chambers without damage to the o-ring. Moreover, because the line of chambers do not need to move laterally to create space for removing and/or inserting a single chamber into a preexisting line of chambers, much less disconnection and movement of electrical and plumbing lines needs to occur. This results in a more efficient repair and replacement process and a more productive manufacturing line, which increases productivity and profits.

The above-described embodiments and configurations are not intended to be complete nor exhaustive. As will be appreciated, other embodiments of the invention are possible utilizing, alone or in combination, one or more features set forth above or described below.

### BRIEF DESCRIPTION OF THE DRAWINGS

Several drawings have been developed to assist with understanding the invention. Following is a brief description of the drawings that illustrate the invention and its various embodiments.

FIG. 1 is a perspective view of a row of linearly aligned and interconnected chambers.

FIG. 2 is an exploded perspective view of the sealing interface between adjacent chamber sidewalls,

FIG. 3 is a cross-sectional view of an o-ring positioned within the groove of a chamber sidewall.

FIG. 4 is a cross-sectional view of an o-ring compressed between adjacent chamber sidewalls and forming a seal between the adjacent sidewalls.

FIG. 5 illustrates the resulting shear force on an o-ring of the kind shown in FIG. 4 due to relative motion between chambers.

FIGS. 6A- 6C illustrate a conventional method for chamber removal.

FIG. 7 is a perspective view of a row of linearly aligned chambers of one embodiment of the present invention.

FIG. 8 is an exploded perspective view of the sealing interface between adjacent chamber sidewalls of one embodiment of the present invention.

FIGS. 9A and 9B illustrate a method for chamber removal of one embodiment of the present invention.

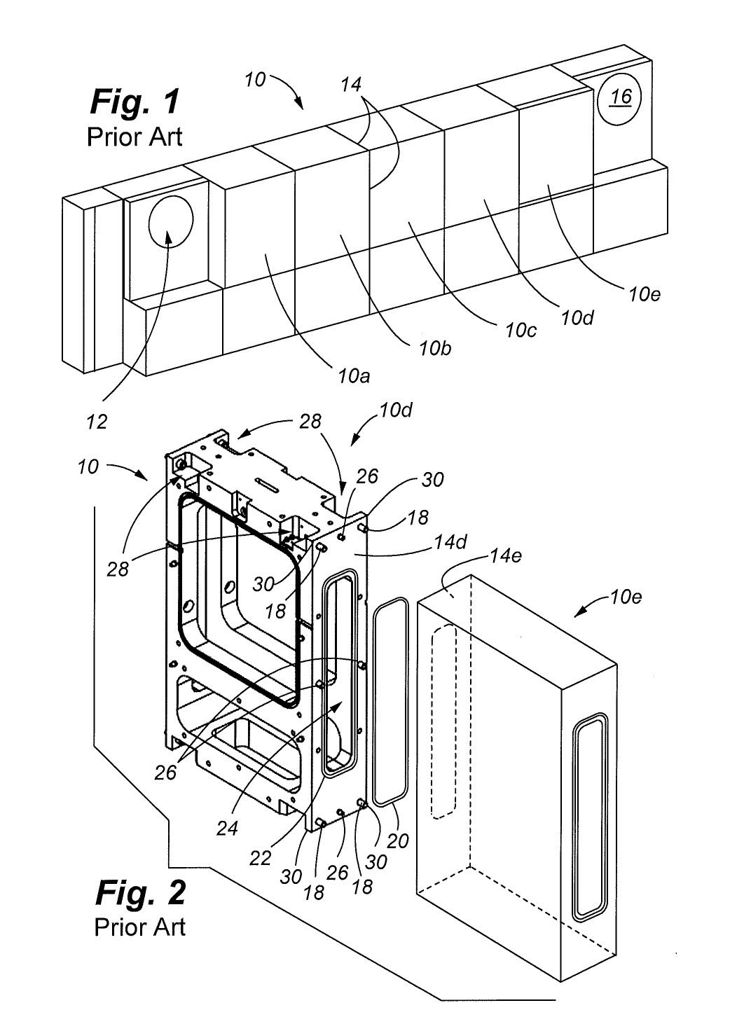

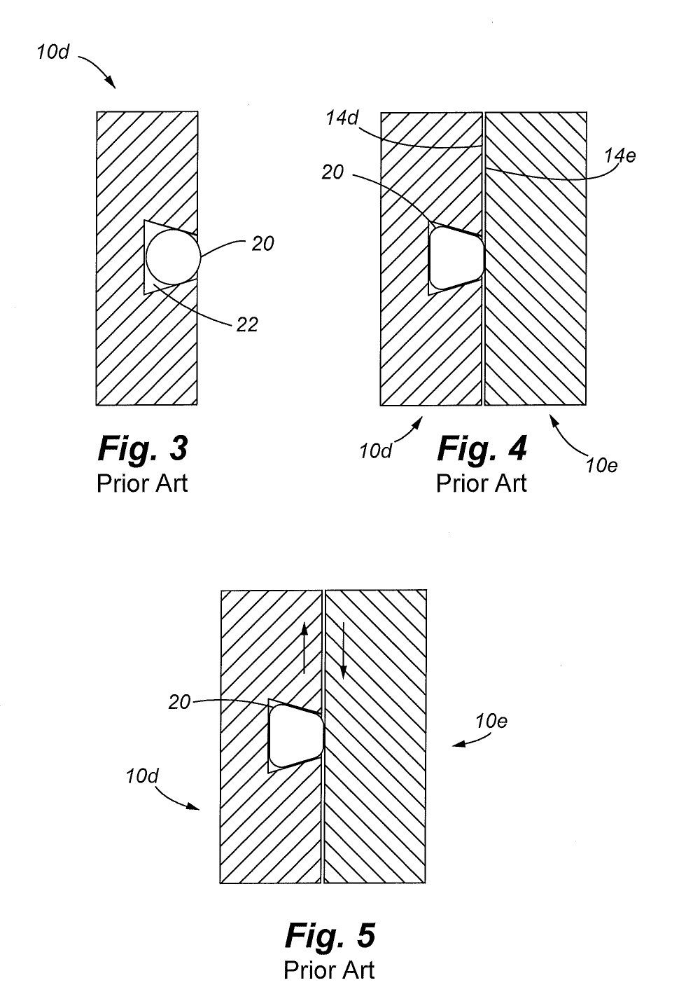

It should be understood that the drawings are not necessarily to scale, and that in certain instances, the disclosure may not include details which are not necessary for an understanding of the present invention, such as conventional details of fabrication and assembly, by those of skill in the art. Also, while the present disclosure describes the invention in connection with those embodiments presented, it should be understood that the invention is not strictly limited to these embodiments.

### DETAILED DESCRIPTION

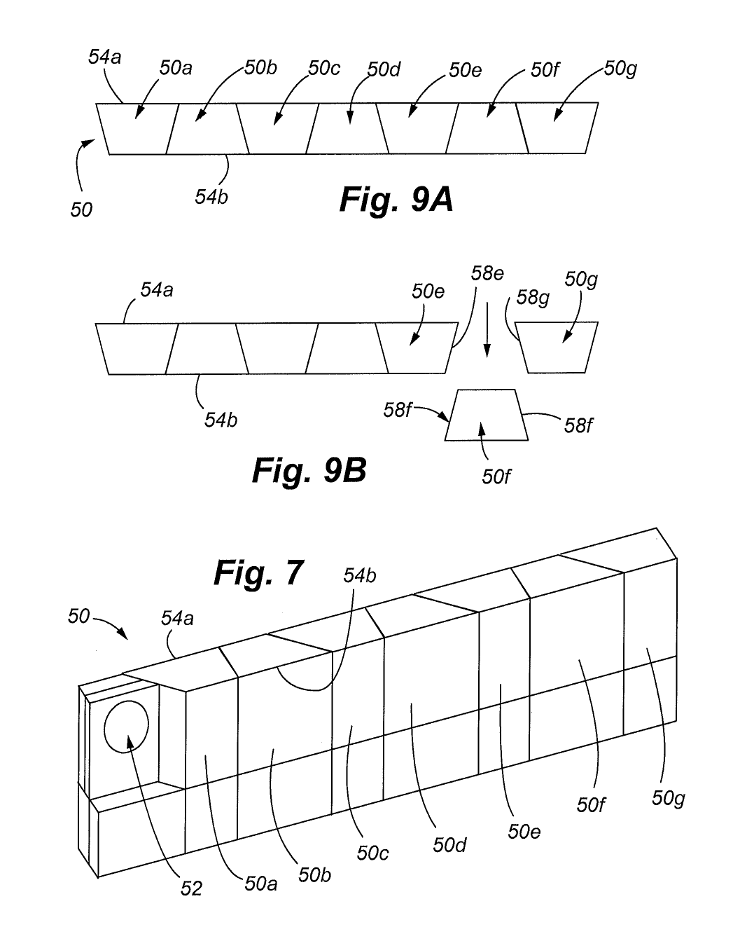

Turning to FIG. 7, one embodiment of the in-line system of linearly aligned trapezoidal chambers 50 of the present invention is illustrated. The disks 52 may travel through the series of chambers 50a-50g using automated means known to those of skill in the art. The disks 52 move along a track running between the trapezoidal chambers 50a-50g. The disks 52 may be processed one at a time or in groups. In the preferred embodiment, the trapezoidal chambers 50a-50g are inversely orientated so that the longer end wall 54 of chambers, for example 54a and 54b, are on opposite sides of the row. The trapezoidal chambers 50 are connected to one another via their sidewalls. Preferably, the chambers 50 are formed in the shape of an isosceles trapezoid. If there are an odd number of chambers, the row of linearly aligned and interconnected chambers will form the shape of a trapezoid. If there are an even number of chambers, the row of linearly aligned and interconnected chambers will form the shape of a parallelogram.

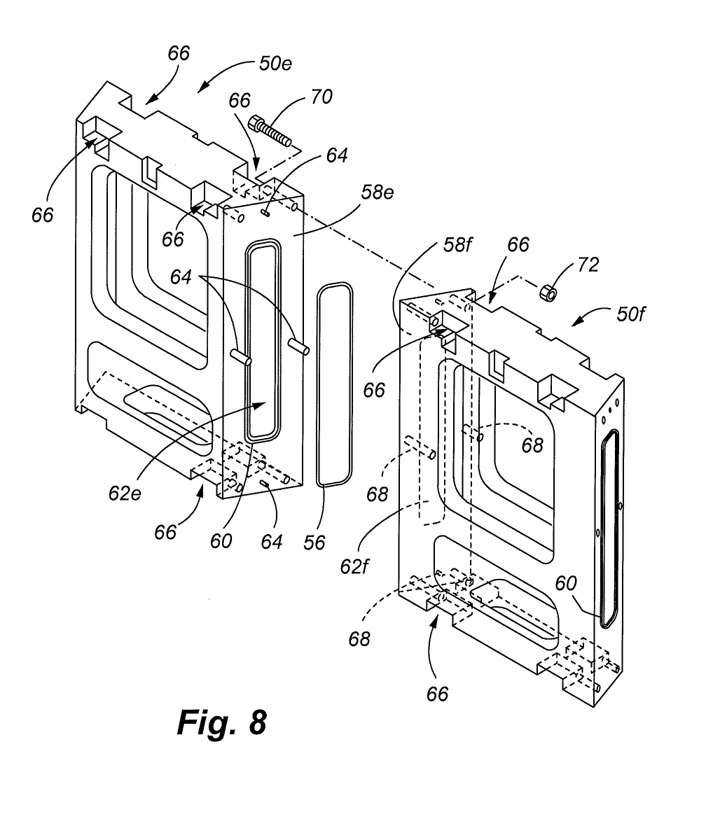

Referring to FIG. 8, the sealing means of one embodiment of the present invention are shown. An o-ring 56 forms a seal between the adjacent trapezoidal chamber sidewalls 58e and 58f of two adjacent chambers 50e and 50f. In one embodiment, the sidewall 58e of chamber 50e includes a groove 60 to receive the o-ring 56. The adjacent sidewall 58f of chamber 50f includes a smooth surface to abut the o-ring 56. The openings 62e and 62f of the adjacent chambers 50e and 50f may then be sealed by compressing the o-ring 56 between the adjacent two sidewalls 58e and 58f.

In one embodiment of the present invention, the sidewall 58e further includes alignment pins 64. The purpose of the alignment pins 64 is to align the adjacent trapezoidal chambers 50e and 50f before the chambers are fastened or secured into place. In one embodiment, cutouts or recesses 66 may be included to provide access to openings 68 designed to receive bolts 70 and nuts 72 to secure adjacent chambers 50e and 50f together. The purpose of the bolts 70 and nuts 72 is to ensure compression of the o-ring 56 between the adjacent chamber sidewalls 58e and 58f sufficient to form a seal. In another embodiment, the adjacent trapezoidal chambers 50e and 50f may be physically interconnected by means of C-clamps spanning the cutouts or recesses 66. In yet another embodiment, the adjacent trapezoidal chambers 50e and 50f may be physically interconnected by means of a threaded bolt and threaded bore. In a further embodiment, adjacent chambers 50e and 50f may be welded together. Different fastening means will be known and appreciated by those skilled in the art to physically interconnect the two adjacent trapezoidal chambers.

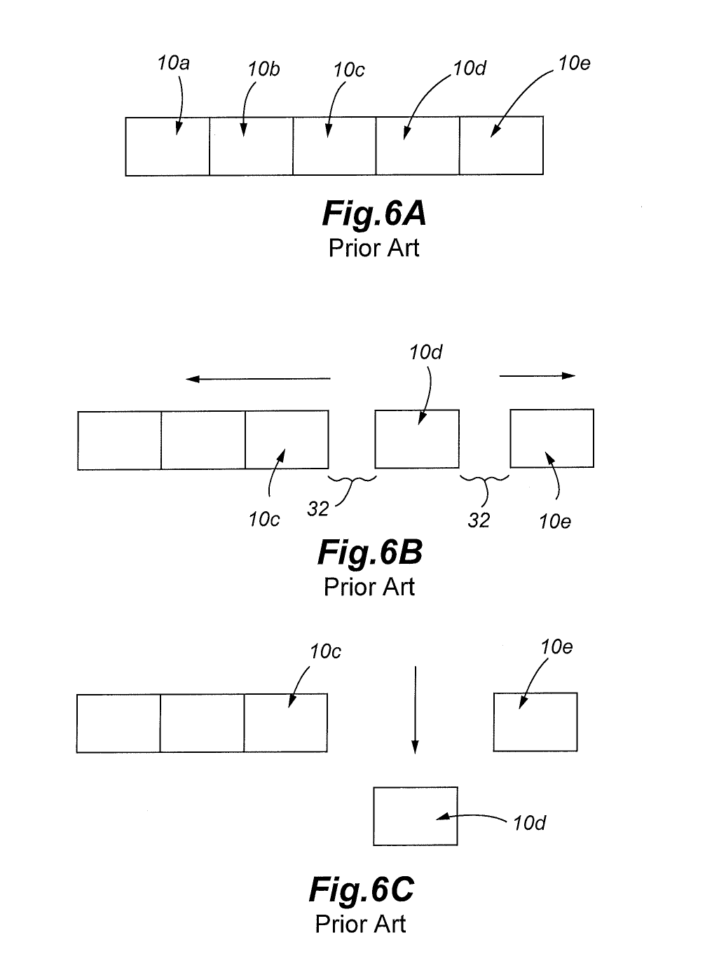

A benefit of the trapezoidal shaped chambers 50a-50g of the present invention is a substantial reduction in chamber exchange time. Unlike the conventional design for chamber removal, which is labor intensive and time consuming, the trapezoidal chamber design streamlines the removal and/or exchange process by eliminating certain steps. Importantly, because the chambers are generally trapezoidal in shape, the operator may easily remove and/or exchange chambers from the in-line row of chambers 50 without moving any other chamber. FIGS. 9A and 9B illustrate one embodiment of the trapezoidal chamber exchange and/or removal process. In one embodiment, when a trapezoidal chamber 50f needs to be serviced, replaced, or otherwise exchanged, the electrical and plumbing lines an disconnected. Then, any mechanical interconnections, such as alignment pins 64, bolts 70, C-clamps, or other fastening means, are uncoupled. Because of the angled sidewalls 58e and 58f and 58f and 58g, the trapezoidal target chamber 50f can then slide out orthogonally relative to its adjacent trapezoidal chambers 50e and 50g (see FIG. 9b). This is an improvement over the conventional removal process because lateral space does not need to be created between the chamber 50f to be removed and the adjacent chambers 50a-50e and 50g before being removed. The geometry of the trapezoidal chambers 50 eliminates the necessity of creating a physical gap 32 between the chambers before removal as illustrated in FIG. 6B. By not having to move all of the chambers in the in-line row 50 to create a gap 32, substantial time is saved in the chamber exchange and/or removal process. Moreover, additional time is saved once the trapezoidal target chamber 50f is ready to be reinserted into the in-line row of trapezoidal chambers 50 because the trapezoidal target chamber 50f can be positioned into the row of chambers 50 without having to remove a previously created physical gap 32. Similarly, the electrical and plumbing lines associated with those chambers may remain in place and do not need to be moved either. Once the inserted trapezoidal target chamber 50f is aligned, the trapezoidal target chamber 50f may be recoupled to the adjacent trapezoidal chambers 50e and 50g and then the electrical and plumbing lines may be reconnected. Overall, the modular trapezoidal chamber 50 design substantially reduces the chamber exchange time. Because the trapezoidal chamber exchange/removal process takes less time the disk processing line may be stopped for less time. Thus, by minimizing the time the disk processing line is nonoperational the amount of disk throughput is increased.

A further benefit of present invention is that the trapezoidal chamber design decreases the amount of labor required to remove and/or exchange a chamber. The aforementioned savings in time correlate to a similar savings in labor. Less labor is required to remove and/or exchange a chamber because the trapezoidal chambers 50 do not require a gap 32 be present between adjacent chambers 50e and 50g before the target chamber 50f is exchanged. Similarly, less labor is required when a trapezoidal chamber 50 is reinserted because it can positioned in-line more easily without the need to remove a gap 32. The trapezoidal chamber design requires fewer steps; thus, less labor is required to exchange trapezoidal chambers 50.

A still further benefit of the trapezoidal chambers 50 of the present invention is that the shearing forces are reduced during chamber removal and/or exchange. Because the trapezoidal chamber 50f is more easily able to slide out from the in-line row of chambers 50, less shear force is exerted on the o-ring 56. Moreover, because the trapezoidal chamber 50f may be more easily reinserted back into the in-line row of chambers 50, less shear force is exerted on the o-ring during reinsertion. Thus, the o-ring 56 is unlikely to become dislodged or damaged and a seal is more likely to be achieved between adjacent trapezoidal chambers 50e and 50f. Additionally, less shear stress on the o-ring 56 will extend the life of the o-ring 56.

Although this invention has been disclosed and illustrated with reference to particular embodiments, the principles involved are susceptible for use in other embodiments that will be apparent to persons skilled in the art. For example, the trapezoid shape of the chambers may vary from chamber to chamber as long as adjacent side walls of a bolting chamber are parallel. Thus, the chambers do not need to be shaped in the form of an isosceles trapezoid. This invention is, therefore, to be construed only as indicated by the scope of the claims and not limited to the embodiments described herein.

The foregoing discussion of the invention has been presented for purposes of illustration and description. The foregoing is not intended to limit the invention to the form or forms disclosed herein. In the foregoing description for example, various features of the invention have been identified. It should be appreciated that these features may be combined together into a single embodiment or in various other combinations as appropriate for the intended end use of the band. The dimensions of the component pieces may also vary, yet still be within the scope of the invention. This method of disclosure is not to be interpreted as reflecting an intention that the claimed invention requires more features than are expressly recited in each claim. Moreover, though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation. Rather, as the following claims reflect, inventive aspects lie in less than all features of any single foregoing disclosed embodiment. Thus, the following claims are hereby incorporated into this Detailed Description, with each claim standing on its own as a separate preferred embodiment of the invention.

What is claimed is:

1. An apparatus for use in making magnetic disks, comprising, a body defining a chamber, the body having four outer side surfaces which substantially form the shape of a trapezoid.

2. The apparatus of claim 1, wherein the trapezoid is an isosceles trapezoid.

3. The apparatus of claim 1, wherein the four outer surfaces comprise a front surface, a back surface, a first side surface and a second side surface, the front and back surfaces are substantially parallel and one of the front surface and back surface has a shorter length than the other, and the first side surface and the second side surface are of substantially equal length.

4. The apparatus of claim 1, further comprising:
a. a second body defining a second chamber, the second body having at least four outer side surfaces, the four outer side surfaces of the second body comprising a front surface, a back surface, a first side surface and a second side surface, the front and back surfaces are substantially parallel and one of the front surface and the back surface has a shorter length than the other, and the first side surface and the second side surface are of substantially equal length; and
b. the first and second bodies are interconnected with the first side surface of the first chamber positioned adjacent to the second side surface of the second chamber, with the interconnected first and second bodies substantially forming the shape of a parallelogram.

5. The apparatus of claim 4, wherein both the first side surface of the first chamber and the second side surface of the second chamber have openings to permit one or more disks to move from the first chamber to the second chamber.

6. The apparatus of claim 5, further comprising a groove formed in the first side surface of the first chamber and surrounding the opening formed in the first side surface, and a seal positioned in said groove.

7. The apparatus of claim 6, wherein the seal abuts the second side surface of the second chamber and surrounds the opening in the second side surface of the second chamber when the first and second bodies are interconnected.

8. An apparatus for making magnetic disks, comprising:
a. A plurality of linearly aligned chambers, said chambers interconnected such that one or more disks may pass from one chamber to the next adjacent chamber for processing; and
b. A plurality of the chambers being formed in the shape of a trapezoid.

9. The apparatus of claim 8, wherein each of the plurality of chambers are substantially formed in the shape of an isosceles trapezoid.

10. The apparatus of claim 8, wherein the plurality of chambers is an odd number of chambers and the plurality of chambers substantially forms the shape of a trapezoid.

11. The apparatus of claim 8, wherein the plurality of chambers is an even number of chambers and the plurality of chambers substantially forms the shape of a parallelogram.

12. In a row of linearly aligned and interconnected chambers used in making magnetic disks used in disk drives, the row of chambers further comprising an end chamber at each end of the row and at least one interior chamber positioned between the end chambers, a method for maintaining the row of linearly aligned chambers, the method comprising:
a. Disconnecting an interior chamber from adjacent chambers; and
b. Removing the interior chamber from the row of linearly aligned chambers without moving any of the other chambers.

13. The method of claim 12, wherein moving the interior chamber comprises moving the chamber along a path perpendicular to the row of linearly aligned and interconnected chambers.

14. The method of claim 12, wherein a seal is positioned between the interior chamber and an adjacent chamber, further comprising moving the interior chamber without damaging the seal.

15. The method of claim 12, further comprising inserting the same or a different interior chamber into the space created by removing the interior chamber, and connecting the inserted chamber to the adjacent chambers without moving the adjacent chambers.

16. The method of claim 15, wherein a seal is positioned between the inserted chamber and an adjacent chamber and the seal is not damaged or destroyed by inserting the chamber into the row of linearly aligned chambers.
